(19) United States
(12) Patent Application Publication
(10) Pub. No.: US 2020/0082339 A1
(43) Pub. Date: Mar. 12, 2020

(54) END-OF-LIFE PRE-PLAN ORGANIZATION

(71) Applicant: Justin O'Keefe, Biloxi, MS (US)

(72) Inventor: Justin O'Keefe, Biloxi, MS (US)

(21) Appl. No.: 16/128,814

(22) Filed: Sep. 12, 2018

(51) Int. Cl. G06Q 10/10; G06Q 10/08

(52) U.S. Cl. CPC G06Q 10/10; G06Q 10/087

(57) ABSTRACT

An end-of-life pre-plan organization method and kit providing an increase in wealth and well-being of the person anticipating eventual death and a decrease in trouble, confusion, and expense to anticipated survivors, heirs, and beneficiaries upon the eventual death.

### BACKGROUND

This invention provides an end-of-life pre-plan organization method and kit.

A person's death can be an unnecessarily costly and confusing ordeal for the family, loved ones, survivors, heirs, and beneficiaries of the person. In the absence of pre-planning, even very basic choices such as cremation, burial, or donation can become a source of disagreement among surviving family members, and even an informally stated preference by the person might be overlooked, ignored, or intentionally dishonored. Money might be needlessly spent on services or items that the person would have felt were unneeded or excessive. If the person had associations with other people or with organizations in far-flung locations, those people and organizations might not be made aware of the death in a timely manner, such as in time to attend a funeral or memorial service. The person's financial circumstances late in life might be negatively affected by such things as an inability to manage one's own affairs due to infirmity or mismanagement by other people or organizations. A person's estate might be subject to taxes and costs that diminish the amount or the value of assets left to survivors, heirs, and beneficiaries, where a re-structuring of the estate before death might have made for an easier and less costly transfer.

The prior art does not provide for an end-of-life pre-plan organization method and kit that results in an increase in wealth and well-being of the person anticipating eventual death and a decrease in trouble, confusion, and expense to the anticipated survivors, heirs, and beneficiaries upon the eventual death of the person.

For example, U.S. Patent Application Publication No. 2013/0290198 for an “Estate and Life Event Organization and Management System,” as published on Oct. 31, 2013 by inventor Lenore Vassil, discloses an estate organization system that includes a plurality of user computers, a plurality of entity computers, a network, and one or more server computers implementing a software environment. The software environment provides checklists, “to do” lists, and a scoring methodology to encourage a user to organize his or her estate. At least one user computer is used by a person organizing their estate, at least one user computer is used by a person who is a loved one of the person organizing their estate, and at least one computer is used by a professional services provider who is interested in providing estate planning or related services to the person organizing their estate and/or the loved one.

U.S. Patent Application Publication No. 2006/0290135 for a “Financial Planning Tool,” as published on Dec. 28, 2006 by inventor Michael A. Altman, discloses an apparatus and method of simplifying one's life in the organization, retention, transportation, disclosure and use of financial planning documentation and related items. The apparatus is a pre-printed “SIMPLIFY YOUR LIFE BOX” Document Summary Form to add specific financial planning information and a portable case. The method of using the device involves filling in the pre-printed “SIMPLIFY YOUR LIFE BOX” Document Summary Form; and, placing it and such of the referenced documents and associated items as are available in the portable case. Specifically included, is a form entitled “Where Can I Find It Information,” which includes location information on keys to safety deposit boxes, keys to homes, keys to post office box, extra set of keys to automobiles, keys to safe at home, passwords to computer programs, credit card registry information, divorce decrees, deeds to real estate, title to automobiles. All of this information is essential to the unfettered operation of the owner's financial affairs. Also included is a form entitled “Financial Information,” which includes notations of the existence and location of a financial planning book, investment statements, bank statements, retirement account statements, employee benefit manual or summary, tax returns, tax receipts, life insurance policies and statements, disability policies and statements, long-term care policies and statements, homeowners policies and statements, automobile policies and statements, medical insurance policies and statements, wills, medical power of attorney, living will, durable power of attorney, special trusts, mortgages, investment cost basis, home improvements, rental property, loans, credit card statements, birth certificates and social security cards. Knowledge of this information is again essential to the unfettered operation of the owner's financial affairs. Moreover, included is a form entitled “In the Event of Death Information,” which includes identification and useful information on the owner's financial advisor, attorney, accountant, cemetery deed, funeral prearrangements, location of wills, organ donor card, eulogy information, list of family and friends to notify, transfer of frequent flyer miles, and instructions on where to send copies of the death certificate. This information will facilitate the administration of the owner's estate and the concluding of his financial affairs.

U.S. Patent Application Publication No. 2016/0283877 for a “Death Care Management System and Method,” as published on Sep. 29, 2016 by inventors G. Scott Mindrum et al., discloses a system that provides automated and semi-automated tools and methods that may be used by providers in the death care industry to manage time sensitive tasks and share information with third party providers of goods and services.

U.S. Patent Application Publication No. 2015/0242814 for “Systems and Methods for Handling Social Digital Accounts and Assets upon Death or Incapacitation,” as published on Aug. 27, 2015 by inventor Rana A. Saad, discloses a system to allow users to specify how they would like to treat their digital assets embedded in their online and social accounts upon their death, by choosing one or a mix of numerous options for online verification and confirmation of a person's death by comparing against the online death records of all the States; and a system and protocol for second level verification of the death from the next-of-kin or a person designated by the user to be passed on to the beneficiary.

U.S. Patent Application Publication No. 2015/0019449 for a “Method to Transfer Personal Financial Information and Other Hard to Replace Documents to a Selected Recipient Post Death,” as published on Jan. 15, 2015 by inventor Navin Murli Lalwani, discloses a safe, secure, and reliable process that allows a family member to select one or more loved ones who should be able to receive all the financial details, hard to replace documents, and other information of a person in case of an unfortunate sudden death. The system and methods surrounding this process can help avoid the various follow ups and errands that might be required with various agencies, such as banks, creditors, tax agents, insurance companies, and the like, to find all of the related and necessary information. More specifically, a new user can register (create a profile) himself using the GUI and updates all information. The user can update all information for each section, including assets, liabilities, and document uploads. The data can cover practically any data the user wishes to store. Specific examples of profile data include user details, user contact details, membership details, and user preference settings. Specific examples of asset data include bank accounts, insurance policies, fixed deposits, trading accounts, stocks, bonds, retirement accounts, collectibles, art, jewelry, furnishings, and the like. Specific examples of liabilities include credit cards, direct debit payments (such as utility bills, phone bills, car loan payments, homeowner's association fees, mortgages, magazine subscriptions, life insurance premiums, health insurance premiums, newspaper subscriptions, and the like), and loans (such as home loans, car loans, student loans, and the like). Specific examples of data uploads include important documents such as wills, property deeds, birth certificates, company documents, important bills, passport copies, and other hard to replace documents. Specific examples of information under the information recipients tab can include name, relationship, email, phone number, status (such as confirmed, pending, or the like), test a report (to test run a report that will be sent to the beneficiary), and action (to edit or delete information). The user can then select one or more information recipients. With this function the registered user can select multiple individuals who can receive the information after his or her death. The user can enter the first name, last name, email and phone number of the person he wishes to select as an information recipient. An email can be sent out to that selected information recipient requesting to “Accept” or “Reject” the information recipient role. If the selected information recipient “Accepts” the request, then he/she shall be navigated to the new screen to create a 4-digit security PIN, two security questions, and confirm date of birth. Once completed, an email confirmation is sent to the registered user notifying that the information recipient has confirmed the request and an email is sent to the information recipient which describes the steps the information recipient needs to take when claiming all the information. After the death of the user, an information recipient can submit a request for registered user's information. The information recipient can navigate to the website homepage (or access appropriate software and/or applications, or the like) and click on the “File a Claim” link to claim information of registered user.

U.S. Patent Application Publication No. 2017/0132736 for a “Deceased Notification System and Method,” as published on May 11, 2017 by inventor William Hampton Switzer, Sr., discloses a deceased notification system utilizing hub and spoke architecture to facilitate notifications to multiple organizations. By having all disparate and disjointed company deceased notification processes and their corresponding required documentation self-contained in one system, the invention provides a means for those settling estates to utilize a “hub and spoke” model to provide deceased notifications, whereby they register someone's death at the hub, and have the system proactively push deceased notifications to all pertinent organizations at the earliest time. This will save all parties time, provide quicker notifications to prevent deceased identity theft, as well as the stoppage of charges for services that are no longer needed by the decedent.

U.S. Patent Application Publication No. 2008/0163342 for a “System and Method for Managing Information Relating to End-of-Life Issues,” as published on Jul. 3, 2008 by inventor David L. Christopherson, discloses a system and method for securely and centrally storing, updating, and transferring information pertaining to the end-of-life issues of an administrator. The information can be input into the system by an administrator or by the administrator's representative. The information is input and stored within topical folders and sub-folders, making the information easy to locate again in the future by the representative.

U.S. Patent Application Publication No. 2003/0182290 for an “Integrated Life Planning Method and Systems and Products for Implementation,” as published on Sep. 25, 2003 by inventor Denise S. Parker, discloses a method for facilitating final estate planning that comprises gathering data in response to a series of questions organized into four points of estate planning, which are (1) client assets; (2) client fiscal and human/pet care responsibilities (i.e. creditors, children, spouse, employers, and others that are dependent upon the client); (3) desired disposition of the client's body before (e.g., assisted living, hospice, palliative care, life support) and after death (corporal disposition); and (4) funding arrangements and documentation for asset disposition to cover fiscal, human/pet care responsibilities, living body and subsequent remains disposition, and to carry out the client's other wishes. A system for performing the method includes a computer program that is preferably accessible via an Internet web site. A unique identification card, known as a Denicard™, is provided which includes information for accessing the bearer's or owner's end of life plans and data that is stored in a database accessible via the web site or a designated entity, wherein the stored data is generated by the system when the financial estate planning method was performed.

Lastly, U.S. Patent Application Publication No. 2018/0137585 for “Estate Planning and Administration,” as published on May 17, 2018 by inventor Marius Van Niekerk, discloses an estate management platform for administering estate data of a person, which includes a remote access interface for receiving incoming data connections, the remote access facility having secure data access facility and being operable to access an estate database and an estate database, including a predefined structure of estate categories for storing estate data of a person in predefined estate categories.

### SUMMARY OF THE INVENTION

This invention provides an end-of-life pre-plan organization method and kit providing an increase in wealth and well-being of the person anticipating eventual death and a decrease in trouble, confusion, and expense to anticipated survivors, heirs, and beneficiaries upon the eventual death.

Relevant information is collected and analyzed, and disposition options are presented to and determined by the person. Unmet needs are identified from information collected and are analyzed, and solutions are proposed. Before and after death, the person's decisions are implemented.

### BRIEF DESCRIPTION OF THE DRAWINGS

Reference will now be made to the drawings, wherein like parts are designated by like numerals, and wherein:

FIG. 1 is a summary chart of the end-of-life pre-plan organization method of the invention;

FIG. 2 is a representation of Form A of the end-of-life pre-plan organization method kit of the invention;

FIG. 3 is a representation of Form B of the end-of-life pre-plan organization method kit of the invention; and

FIG. 4 is a representation of Form C of the end-of-life pre-plan organization method kit of the invention.

### DETAILED DESCRIPTION OF THE INVENTION

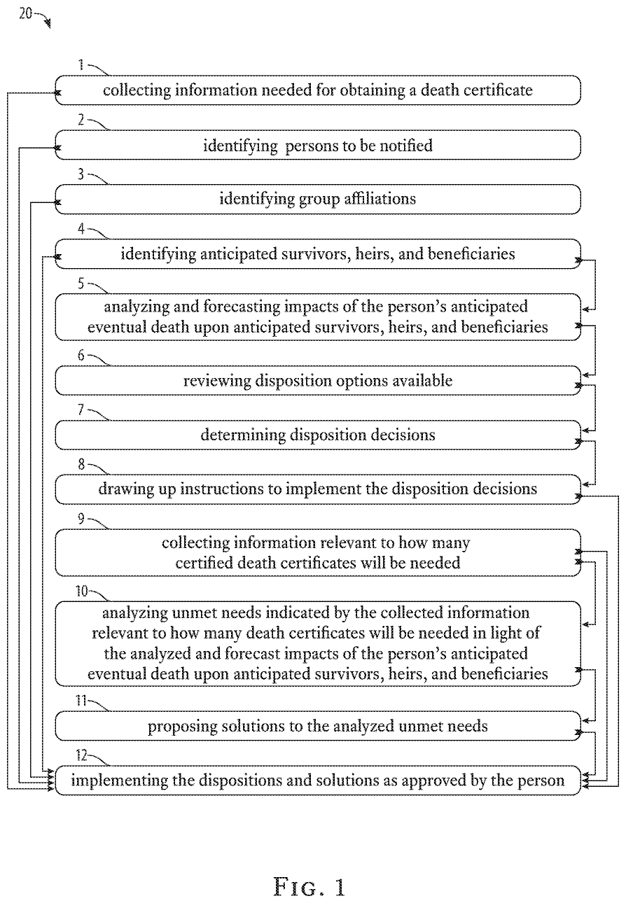

Referring to FIG. 1, an end-of-life pre-plan organization method 20 and kit provides an increase in wealth and well-being of the person anticipating eventual death and a decrease in trouble, confusion, and expense to anticipated survivors, heirs, and beneficiaries upon the eventual death.

Step 1 of the end-of-life pre-plan organization method 20 is collecting information needed for obtaining a death certificate, including full name, addresses, date of birth, birthplace, gender, social security number, occupation and type of business, education, ancestry or race, marital status, including name of spouse and date and place of marriage if applicable, and father's and mother's names and birthplaces.

Step 2 of the end-of-life pre-plan organization method 20 is identifying persons to be notified, by full names, addresses, and contact information, including emergency contacts and persons to be responsible for final arrangements, and other persons.

Step 3 of the end-of-life pre-plan organization method 20 is identifying group affiliations, including any military service, religious, and/or social affiliations.

Step 4 of the end-of-life pre-plan organization method 20 is identifying anticipated survivors, heirs, and beneficiaries, including insurance beneficiaries.

Step 5 of the end-of-life pre-plan organization method 20 is analyzing and forecasting impacts of the person's anticipated eventual death upon said anticipated survivors, heirs, and beneficiaries, by identifying the person's current financial circumstances and likely increases or decreases over time.

Step 6 of the end-of-life pre-plan organization method 20 is reviewing disposition options available, such as cremation, burial, or donation, and the many particulars associated with each option and costs.

Step 7 of the end-of-life pre-plan organization method 20 is determining disposition decisions made by the person after review.

Step 8 of the end-of-life pre-plan organization method 20 is drawing up instructions to implement the disposition decisions made by the person.

Step 9 of the end-of-life pre-plan organization method 20 is collecting information relevant to how many certified death certificates will be needed. Such relevant information will include information about mortgages, debts, and other liabilities, and about investments, accounts, annuities, retirement benefits, and other assets.

Step 10 of the end-of-life pre-plan organization method 20 is analyzing unmet needs indicated by the collected information relevant to how many death certificates will be needed in light of the analyzed and forecast impacts of the person's anticipated eventual death upon the anticipated survivors, heirs, and beneficiaries, including anticipated taxes and other costs of transferring assets and settling liabilities.

Step 11 of the end-of-life pre-plan organization method 20 is proposing solutions to the analyzed unmet needs, including modifications to the person's specific liabilities, assets, and investments. Such solutions should improve the person's circumstances during the rest of life and reduce the potential costs and complications experienced by anticipated survivors, heirs, and beneficiaries after the person's death.

Step 12 of the end-of-life pre-plan organization method 20 is implementing the dispositions and solutions as approved by the person. Implementation of the dispositions can begin with the person pre-paying for, or otherwise contracting for, specific services or items, such as a cemetery plot, a casket, or an urn. Implementation of the dispositions will culminate with the provision of services and items after the person's death, including disposition of the person's remains according to the person's stated wishes.

A kit can be provided to assist with implementation of the end-of-life pre-plan organization method. The kit provides three forms, Form A, Form B, and Form C, for the gathering of information, plus ancillary documents such as printed brochures or audio or video presentations providing information for the person to consider, including costs of various disposition options. This kit can be implemented on paper, such as printed forms and brochures, and can be implemented through communications technology such as a computer program, an Internet website, or a mobile application for smartphones, tablets, and the like.

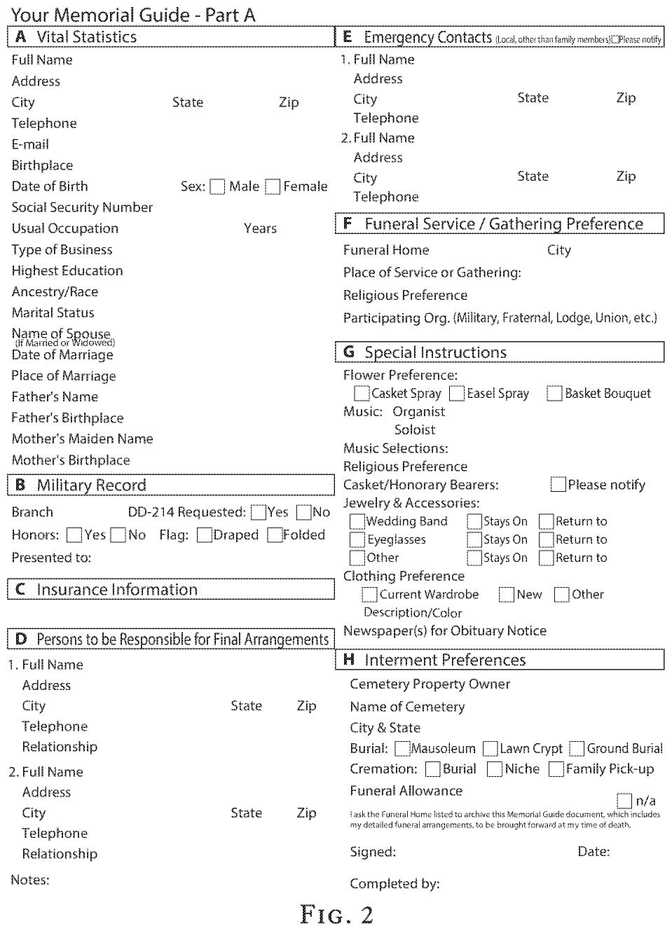

Referring to FIG. 2, Form A collects information needed for obtaining a death certificate, identifying emergency contacts and persons to be notified, identifying group affiliations, including any military service, identifying insurance policies, and identifying the disposition options chosen by the person.

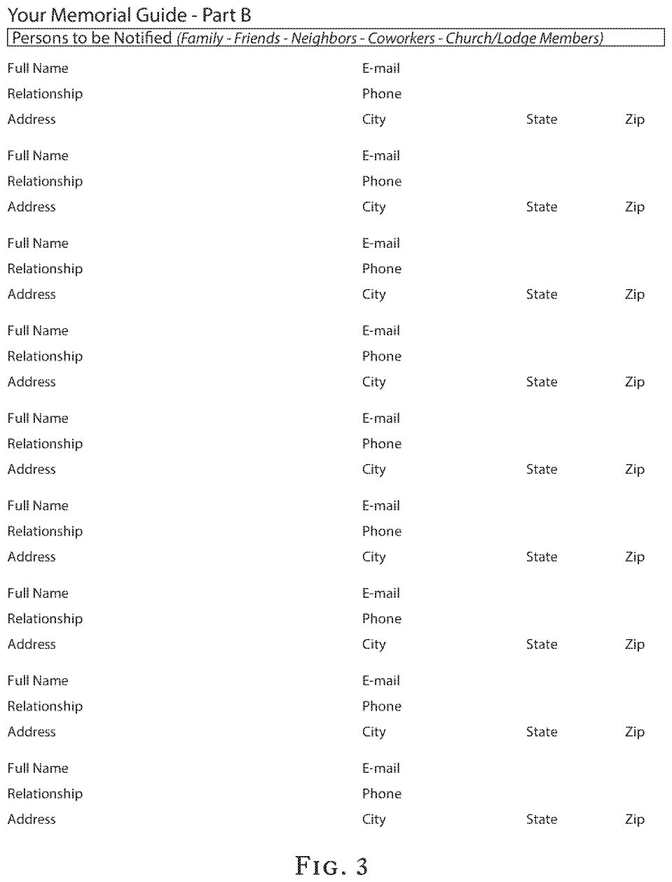

Referring to FIG. 3, Form B collects information, identifying by name, relationship, and contact information, of the persons to be notified upon the death of the person.

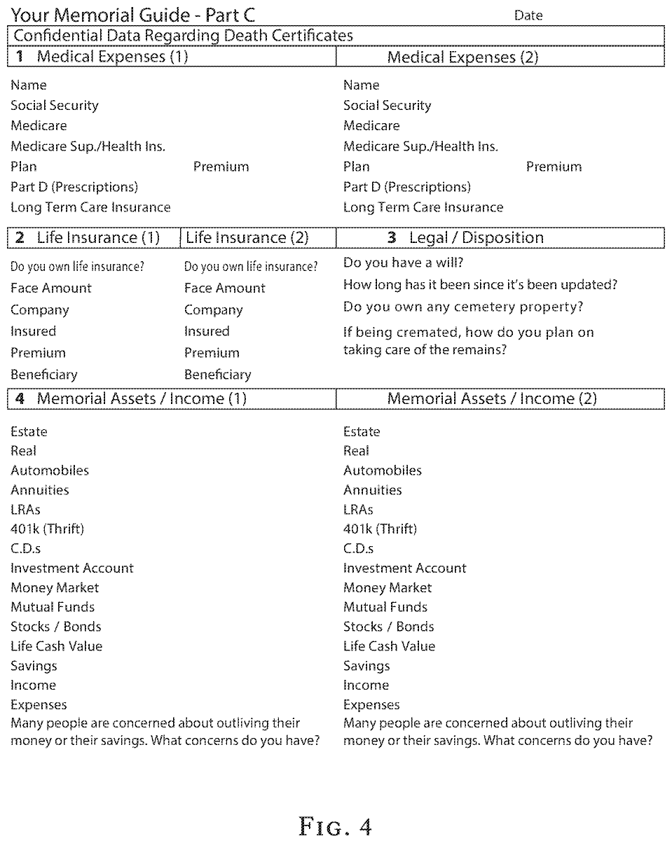

Referring to FIG. 4, Form C collects information needed for determining how many certified death certificates will be needed, and for identification and analysis of unmet needs revealed by the information.

Many other changes and modifications can be made in the system and method of the present invention without departing from the spirit thereof. I therefore pray that my rights to the present invention be limited only by the scope of the appended claims.

I claim:

1. An end-of-life pre-plan organization method for a person anticipating eventual death, the end-of-life pre-plan organization method comprising:
(i) collecting information needed for obtaining a death certificate;
(ii) identifying persons to be notified;
(iii) identifying group affiliations;
(iv) identifying anticipated survivors, heirs, and beneficiaries;
(v) analyzing and forecasting impacts of the person's anticipated eventual death upon said anticipated survivors, heirs, and beneficiaries;
(vi) reviewing disposition options available;
(vii) determining disposition decisions;
(viii) drawing up instructions to implement said disposition decisions;
(ix) collecting information relevant to how many certified death certificates will be needed;
(x) analyzing unmet needs indicated by said collected information relevant to how many death certificates will be needed in light of said analyzed and forecast impacts of the person's anticipated eventual death upon said anticipated survivors, heirs, and beneficiaries;
(xi) proposing solutions to said analyzed unmet needs; and
(xii) implementing said dispositions and solutions as approved by the person;
where said end-of-life pre-plan organization method results in an increase in wealth and well-being of the person anticipating eventual death and a decrease in trouble, confusion, and expense to said anticipated survivors, heirs, and beneficiaries upon the eventual death.

2. The end-of-life pre-plan organization method of claim 1, further comprising pre-purchasing goods and services indicated by said determined disposition decisions.

3. The end-of-life pre-plan organization method of claim 1, further comprising pre-printed forms adapted to obtain said collected information.

4. The end-of-life pre-plan organization method of claim 1, further comprising a computer program adapted to obtain said collected information.

5. The end-of-life pre-plan organization method of claim 1, further comprising an Internet website adapted to obtain said collected information.

6. The end-of-life pre-plan organization method of claim 1, further comprising a mobile application adapted to obtain said collected information.

7. The end-of-life pre-plan organization method of claim 1, where said collected information needed for obtaining a death certificate, identifying emergency contacts and persons to be notified, identifying group affiliations, including any military service, identifying insurance policies, and identifying the disposition options chosen is provided by a Form A as described.

8. The end-of-life pre-plan organization method of claim 1, where said persons to be notified, identifying by name, relationship, and contact information, upon the death is provided by a Form B as described.

9. The end-of-life pre-plan organization method of claim 1, where said collected information relevant for determining how many certified death certificates will be needed, and for identification and analysis of unmet needs revealed by the information, is provided by a Form C as described.

10. The end-of-life pre-plan organization method of claim 1, where said collected information is provided by a Form A, Form B, and Form C as described.

11. An end-of-life pre-plan organization kit comprising:
(i) a Form A as described, adapted to collect information needed for obtaining a death certificate, identifying emergency contacts and persons to be notified, identifying group affiliations, including any military service, identifying insurance policies, and identifying the disposition options chosen;
(ii) a Form B as described, adapted to collect information identifying by name, relationship, and contact information the persons to be notified upon the death;
(iii) a Form C as described, adapted to collect information needed for determining how many certified death certificates will be needed, and for identification and analysis of unmet needs revealed by the information;
where said collected information is used to implement an end-of-life pre-plan organization method for a person anticipating eventual death, the end-of-life pre-plan organization method comprising:
(i) collecting information needed for obtaining a death certificate;
(ii) identifying persons to be notified;
(iii) identifying group affiliations;
(iv) identifying anticipated survivors, heirs, and beneficiaries;
(v) analyzing and forecasting impacts of the person's anticipated eventual death upon said anticipated survivors, heirs, and beneficiaries;
(vi) reviewing disposition options available;
(vii) determining disposition decisions;
(viii) drawing up instructions to implement said disposition decisions;
(ix) collecting information relevant to how many certified death certificates will be needed;
(x) analyzing unmet needs indicated by said collected information relevant to how many death certificates will be needed in light of said analyzed and forecast impacts of the person's anticipated eventual death upon said anticipated survivors, heirs, and beneficiaries;
(xi) proposing solutions to said analyzed unmet needs; and
(xii) implementing said dispositions and solutions as approved by the person;
where said end-of-life pre-plan organization method results in an increase in wealth and well-being of the person anticipating eventual death and a decrease in trouble, confusion, and expense to said anticipated survivors, heirs, and beneficiaries upon the eventual death.

12. The end-of-life pre-plan organization kit of claim 11, where said end-of-life pre-plan organization method further comprises pre-purchasing goods and services indicated by said determined disposition decisions.

13. The end-of-life pre-plan organization kit of claim 11, where said end-of-life pre-plan organization method further comprises pre-printed forms adapted to obtain said collected information.

14. The end-of-life pre-plan organization kit of claim 11, where said end-of-life pre-plan organization method further comprises a computer program adapted to obtain said collected information.

15. The end-of-life pre-plan organization kit of claim 11, where said end-of-life pre-plan organization method further comprises an Internet website adapted to obtain said collected information.

16. The end-of-life pre-plan organization kit of claim 11, where said end-of-life pre-plan organization method further comprises a mobile application adapted to obtain said collected information.

17. The end-of-life pre-plan organization kit of claim 11, where said collected information needed for obtaining a death certificate, identifying emergency contacts and persons to be notified, identifying group affiliations, including any military service, identifying insurance policies, and identifying the disposition options chosen is provided by a Form A as described.

18. The end-of-life pre-plan organization kit of claim 11, where said persons to be notified, identifying by name, relationship, and contact information, upon the death is provided by a Form B as described.

19. The end-of-life pre-plan organization kit of claim 11, where said collected information needed for determining how many certified death certificates will be needed, and for identification and analysis of unmet needs revealed by the information, is provided by a Form C as described.

20. The end-of-life pre-plan organization kit of claim 11, where said collected information is provided by a Form A, Form B, and Form C as described.
